(19) United States
(12) Patent Application Publication
(10) Pub. No.: US 2016/0132213 A1
(43) Pub. Date: May 12, 2016

(54) EFFICIENT FACILITATION OF HUMAN REVIEW AND COMPUTATIONAL ANALYSIS

(71) Applicant: International Business Machines Corporation, Armonk, NY (US)

(72) Inventors: Alecio P. D. Binotto, Sao Paulo (BR); Kiran Mantripragada, Carapicuiba (BR); Alberto C. Nogueira Junior, Campinas (BR); Marco A. Stelmar Netto, Sao Paulo (BR); Nicole B. Sultanum, Sao Paulo (BR); Leonardo P. Tizzei, Campinas (BR)

(21) Appl. No.: 14/537,180

(22) Filed: Nov. 10, 2014

(51) Int. Cl. G06F 3/0484; G06F 3/0482

(52) U.S. Cl. CPC G06F 3/04842; G06F 3/0482

(57) ABSTRACT

A method, executed by a computer, for overlapping computer processing and human analysis includes: receiving a set of tasks to be executed on an array of data, receiving a user profile, prioritizing the tasks based on the user profile, partitioning the array of data based on a current task, prioritizing a plurality of data blocks, executing the current task on the plurality of prioritized data blocks, and outputting data results to the user. The method may include monitoring the user's interactions with the data results. The method may also include receiving a task profile, and prioritizing the plurality of data blocks based on the user profile and the task profile. The method may also include speculating on additional tasks that need to be executed. A computer system and computer program product corresponding to the method are also disclosed herein.

### BACKGROUND OF THE INVENTION

The present invention relates generally to the field of data analysis, and more particularly to efficiently facilitating human review and computational analysis.

Analytical workflows in decision-making and scientific discovery are often composed of alternate cycles of heavy data processing and subsequent lengthy human interpretation and analysis. The time for human analysis is inherently costly, so attempts to decrease the analyst's downtime are common. Typically, the attempts to speed up workflows entail accelerating the computational stages through High Performance Computing (HPC) infrastructures and parallel processing.

### SUMMARY

As disclosed herein, a method, executed by a computer, for overlapping computer processing and human analysis includes receiving a set of tasks to be executed on an array of data, receiving a user profile, prioritizing the tasks based on the user profile, partitioning the array of data into a plurality of data blocks based on a current task, prioritizing the plurality of data blocks based on the user profile, executing the current task on the plurality of prioritized data blocks in order of priority, and outputting data results to the user for a data block in response to completing the current task on the data block. The method may include monitoring the user's interactions with the data results and updating the user profile based on these monitored interactions. The method may also include receiving a task profile, and prioritizing the plurality of data blocks based on the user profile and the task profile. The method may also include speculating on additional tasks that need to be executed based on the user profile.

### BRIEF DESCRIPTION OF THE DRAWINGS

FIG. 1 is a functional block diagram depicting one example of a system suitable for executing the methods disclosed herein;

FIG. 2 is a flowchart depicting one embodiment of a method for overlapping computer processing and human analysis in accordance with the present invention;

FIG. 3 is a flow diagram depicting one embodiment of a user interaction method in accordance with the present invention;

FIG. 4 is a diagram depicting one embodiment of a user interface for selecting which user interactions are monitored, in accordance with the present invention;

FIGS. 5a to 5e are diagrams depicting an example of a sample geographical subspace at various stages of processing, in accordance with one embodiment of the present invention;

FIG. 6 is a block diagram depicting one example of a computing apparatus (i.e., computer) suitable for executing the methods disclosed herein.

### DETAILED DESCRIPTION

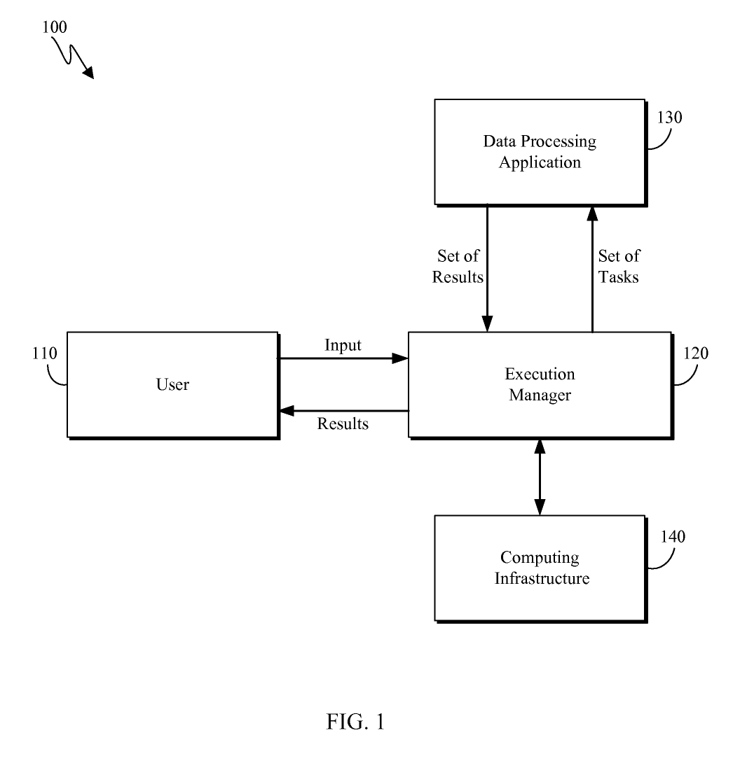

FIG. 1 is a functional block diagram depicting one example of a system 100 suitable for executing the methods disclosed herein. As depicted, the system 100 includes a user 110, an execution manager 120, a data processing application 130, and a computing infrastructure 140. The system 100 is a generic representation of one embodiment of the components required to execute the method for overlapping computer processing and human analysis disclosed herein.

A user 110 may include a person that performs analysis on data outputted by the method disclosed herein. The user 110 may be a single user or a group of users. As depicted, the user provides input to the execution manager 120. The input may include parameters that define how an application, for example, data processing application 130, should be managed.

Execution manager 120 may include software responsible for managing the user application. Managing the user application may include monitoring user activity, partitioning a set of tasks, prioritizing these tasks, receiving user input, and returning results to the user. As depicted, the execution manager 120 returns results to the user after a data processing task is completed.

Data processing application 130 may include software to process a plurality of data blocks and generate a set of results that are analyzed by the user. As depicted, data processing application 130 receives a set of tasks to be executed on a plurality of data blocks from execution manager 120, and then outputs the results of these tasks back to the execution manager 120 upon completion. Data processing application 130 may include software suitable for analyzing a specific type of data, such as earthquake data or surveillance data.

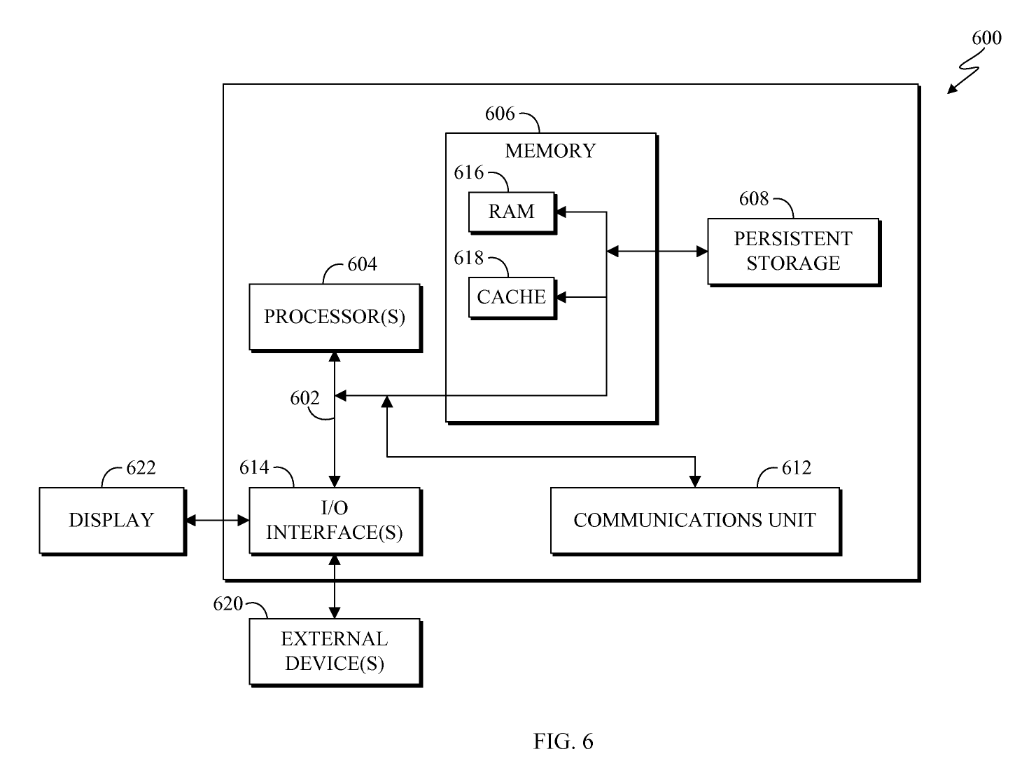

The computing infrastructure 140 may include infrastructure that contains the hardware and software necessary to run data processing applications, and may include components as discussed with reference to FIG. 6.

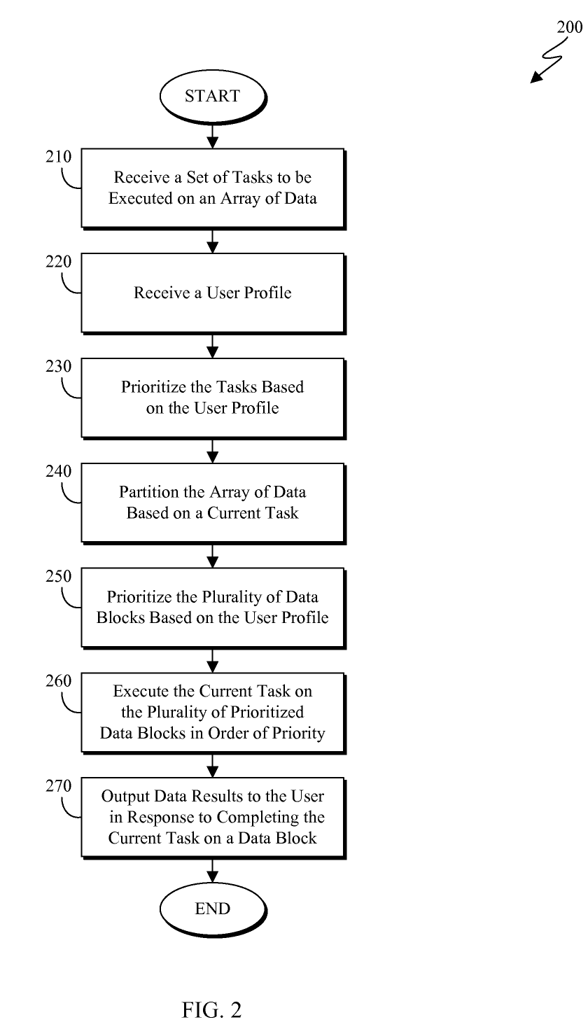

FIG. 2 is a flowchart depicting one embodiment of a method 200 for overlapping computer processing and human analysis in accordance with the present invention. As depicted, the method includes receiving (210) a set of tasks to be executed on an array of data, receiving (220) a user profile, prioritizing (230) the tasks based on the user profile, partitioning (240) the array of data based on a current task, prioritizing (250) the plurality of data blocks based on the user profile, executing (260) the current task on the plurality of prioritized data blocks in order of priority, and outputting (270) data results to the user in response to completing the current task on a data block. The method 200 may also include monitoring the user's interactions with the data results and updating the user profile based on these interactions. The method 200 may also include speculating on additional tasks that need to be executed based on the user profile. In one embodiment, the method 200 is conducted by one or more components of a processing and analysis system such as the system 100 depicted in FIG. 1.

Receiving (210) a set of tasks to be executed on an array of data may include receiving a set of computer processes to be executed on a set of data. The set of tasks may comprise data processing tasks that will be executed to provide data results that a user can analyze. In one embodiment, the set of tasks includes computer processing tasks to be executed on an array of geographic data.

Receiving (220) a user profile may include receiving a profile specific to the user who is interacting with the data results. The user profile may comprise information selected from user experience information, user preference information, and data results interaction information. Receiving a user profile may also include receiving a task profile, wherein the task profile comprises analysis type or analysis activities. The user profile, the task profile, and other profiles disclosed here may be stored on a data storage device associated with the system 100. For example, the computing infrastructure 100 may provide data storage services and/or capacity that is used to store various profiles.

Prioritizing (230) the tasks based on the user profile may include using information in the user profile to identify what order the tasks should be executed in. In some embodiments, prioritizing the tasks based on the user profile includes identifying the past interactions of the user with similar data results, and prioritizing the tasks based on the order in which they were analyzed previously. Prioritizing the tasks based on the user profile may additionally include prioritizing the tasks based on the task profile.

Partitioning (240) the array of data based on a current task may include dividing the array of data into a plurality of data blocks on which the current task will be executed. The partitioning may be done based on the task profile to yield a plurality of data blocks on which the current task can be executed. In some embodiments, partitioning the array of data based on a current task may include dividing the data into small blocks so that the current task can be executed quickly on each small block and results will be available to the user more quickly. In some embodiments, partitioning the array of data based on a current task may include grouping the data into large blocks so that upon completion of the current task on the data blocks, larger scale results will be available to the user for analysis.

Prioritizing (250) the plurality of data blocks based on the user profile may include using information in the user profile to identify in what order the data blocks should be processed. In some embodiments, prioritizing the plurality of data blocks based on the user profile may include identifying the past interactions of the user with similar data results, and prioritizing the data blocks based on the order in which they were analyzed previously. Prioritizing the data blocks based on the user profile may additionally include prioritizing the data blocks based on the task profile.

Executing (260) the current task on the plurality of prioritized data blocks in order of priority may include executing the current task on each prioritized data block, proceeding in order from highest priority to lowest priority. Executing the current task on the plurality of prioritized data blocks in order of priority may also include simultaneously executing the current task on multiple data blocks. Task execution may occur on an elastic execution platform such as a Cloud Computing environment. For example, task execution could occur on a cloud-based implementation of the computing infrastructure 140 shown in FIG. 1.

Outputting (270) data results to the user in response to completing the current task on a data block may include providing the user with the results of executing the current task on a data block. Outputting data results may include directly outputting the data results to the appropriate application managed by the execution manager 120 to facilitate user interaction with the results.

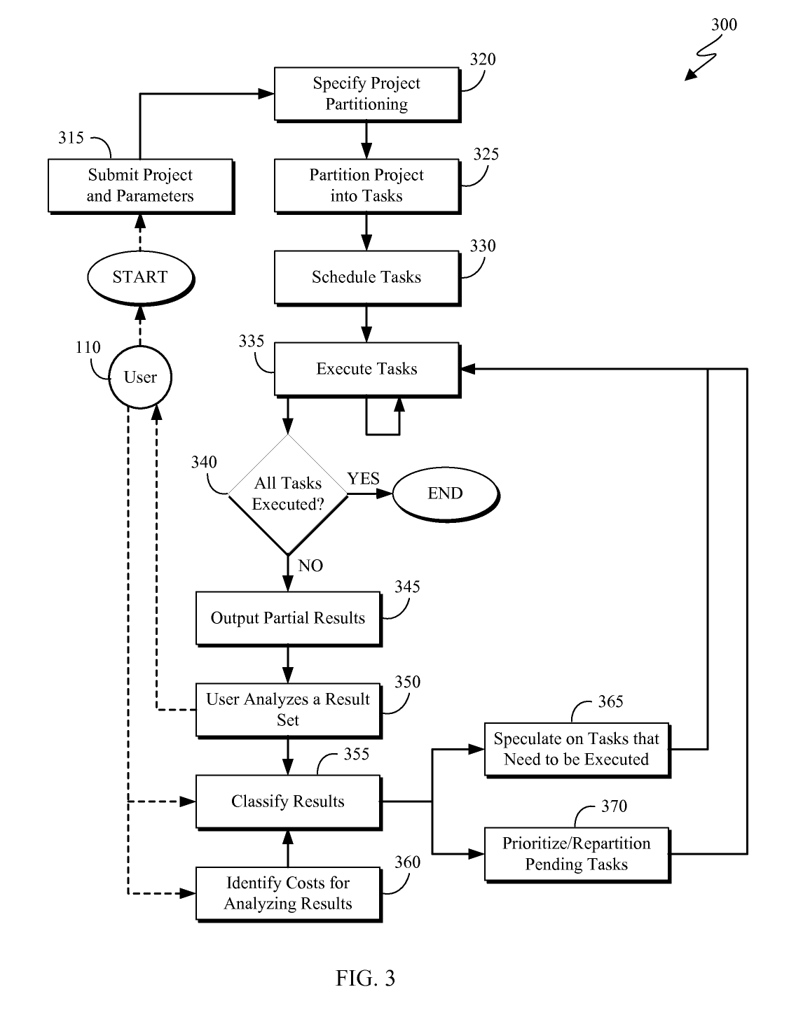

FIG. 3 is a flow diagram depicting one embodiment of a user interaction method 300 in accordance with the present invention. As depicted, the method includes submitting (315) a project and parameters, specifying (320) project partitioning, partitioning (325) the project into tasks, scheduling (330) tasks, executing (335) tasks, determining (340) if all tasks have been executed, outputting (345) partial results, analyzing (350) a result set, classifying (355) results, identifying (360) costs for analyzing the results, speculating (365) on additional tasks that need to be executed, and prioritizing and repartitioning (370) pending tasks. FIG. 3 additionally depicts at which steps the user 110 may interact with the depicted automated process. Such interaction is depicted with dashed lines instead of solid lines (which show process flow).

Submitting (315) a project and parameters may include inputting the project to be managed and associated software to be executed, for example data processing application 130, and any relevant initial parameters for managing the project and executing the associated software to execution manager 120. The project to be executed may comprise a problem or goal to be investigated via computer processing and human analysis. Initial parameters may include deadlines or budget constraints to be considered when determining how tasks will be executed. Submitting a project and parameters is carried out by the user 310.

Specifying (320) project partitioning may include identifying parts of the project that may need to be carried out by different applications. A project may consist of multiple data processing tasks that each need to be executed by different applications. Consequentially, specifying project partitioning may include specifying which parts of the problem need to be carried out by which applications or computing resources.

Partitioning (325) the project into tasks may include automatically converting project goals into functional tasks to be executed by various applications. Functional tasks may include data processing functions carried out by various software applications. Partitioning the project into tasks may include producing a list of processing tasks to be carried out by the relevant software applications or computing resources.

Scheduling (330) tasks may include determining when each task will be carried out by the computer. Scheduling tasks may also include determining how much of the processing can be done simultaneously and maximizing how many tasks are being executed at any one time. Scheduling the tasks may also include ensuring the tasks are carried out in order of priority.

Executing (335) tasks may include carrying out the data processing functions on their respective platforms. Executing tasks may also include executing the tasks according to the previously determined schedule. In some embodiments, where multiple platforms are available for data processing, executing tasks includes simultaneously executing multiple tasks.

Determining (340) if all tasks have been executed includes checking to see if there are any remaining tasks to be executed. If there are not any remaining tasks to be executed (decision block 340, “yes” branch), the process ends. If there are remaining tasks to be executed (decision block 340, “no” branch), the process continues to outputting (345) partial results.

Outputting (345) partial results may include sending a set of data results for a completed task to the user for analysis. In some embodiments, outputting partial results includes sending the results directly to the appropriate software application for analysis. In some embodiments, outputting partial results includes sending the results directly to the user 110 to be analyzed.

Analyzing (350) a result set may include the user 110 interacting with the data results in an appropriate software application. In some embodiments, analyzing a result set may include the execution manager 120 monitoring the user interaction with the data results within the appropriate software application. Specific user interactions with a result set that the execution manager monitors may include mouse clicks, number of data views, the types of Graphical Users Interface (GUI) commands invoked, eye tracking, user edits, annotations, and other kinds of user interactions. The execution manager may update the user profile with information regarding the user interactions. In certain embodiments, analyzing a result set occurs simultaneously with the execution of tasks on data blocks of lower priority.

Classifying (355) results may include the user 110 identifying results that are of particular importance after having analyzed them and assigning higher priority to similar remaining tasks. For example, if the results of one task prove to be particularly insightful during analysis, the user 110 can identify the remaining tasks of this type and classify them with a higher priority. Conversely, if the results of a certain task prove to be minimally useful, the remaining tasks of this type can be classified with a lower priority or cancelled entirely. In some embodiments, the classification of results is carried out by the execution manager 120 based on the user profile. In these embodiments, the user is still able to manually classify the results as well.

Identifying (360) costs for analyzing the results may include the user 110 determining the costs of each type of analysis and considering these costs in the scope of any relevant budget restrictions. The cost of analysis for each task may be used to estimate the costs of analyzing the results of pending tasks, and determining if these tasks are worth completing and analyzing based on the cost. In some embodiments, identifying costs for analyzing the results is carried out by the execution manager 120. In these embodiments, the user is still able to manually determine whether a task is worth completing and analyzing based on the cost.

Speculating (365) on additional tasks that need to be executed may include automatically identifying any tasks that have not been scheduled for execution that may be important in light of the data analysis. In some embodiments, these tasks are previously run tasks that now require increased granularity. Speculating on additional tasks that need to be executed may occur based on user interaction with the data results or past user behavior on similar projects.

Prioritizing and repartitioning (370) pending tasks may include updating the task schedule to reflect any changes in a task's status. Prioritizing and repartitioning may include ensuring any changes in a tasks' priority are reflected in the schedule. Prioritizing and repartitioning may also include ensuring that any tasks that have been divided for the sake of speed or otherwise are properly repartitioned to produce the desired result. Additionally, prioritizing and repartitioning pending tasks may include inserting any speculated additional tasks into the task schedule for completion.

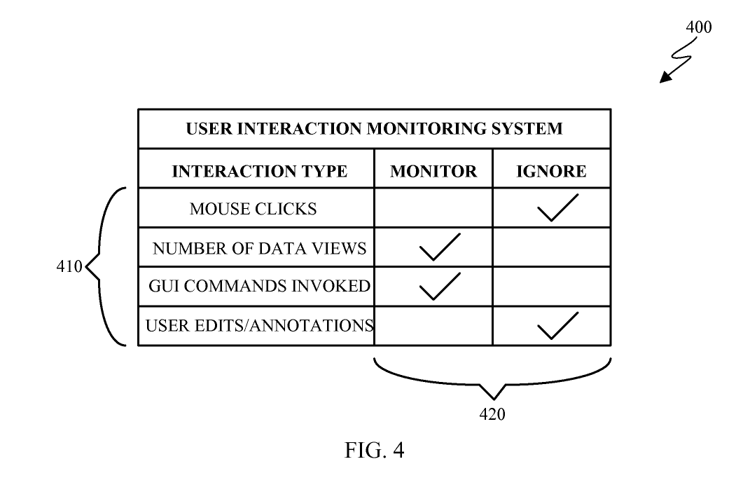

FIG. 4 is a diagram depicting an example of one embodiment of a user interface for selecting which user interactions are monitored and used to update the user profile, which allows the execution manager 120 to prioritize tasks for execution. As depicted, the user interface 400 is a dialog box through which a user 110 may request that certain types of user interactions 410 are either monitored or ignored via the selection boxes 420. The dialog box 400 communicates to the execution manager, for example, execution manager 120, which user interactions to use to update the user profile. The set of user interactions 410 for this particular embodiment are mouse clicks, number of data views, GUI commands invoked, and user edits and annotations. As depicted, the user has opted to have the system monitor the number of data views and GUI commands invoked, and ignore mouse clicks and user edits and annotations. Selecting monitoring for a user interaction type will key the execution manager 120 to track that interaction and update the user profile based on what data results these interactions correspond to. In this embodiment, any data results the user repeatedly invokes a GUI command on or views many times will be marked as an important data type in the user profile. In this particular example, mouse clicks and user edits and annotations will have no effect on the user profile or task prioritization in this embodiment as they have been set to be ignored. It should be noted that this set of user interactions 410 simply serves as a concrete example, and the invention is not limited to this example. For instance, eye tracking or voice commands could be utilized in other embodiments.

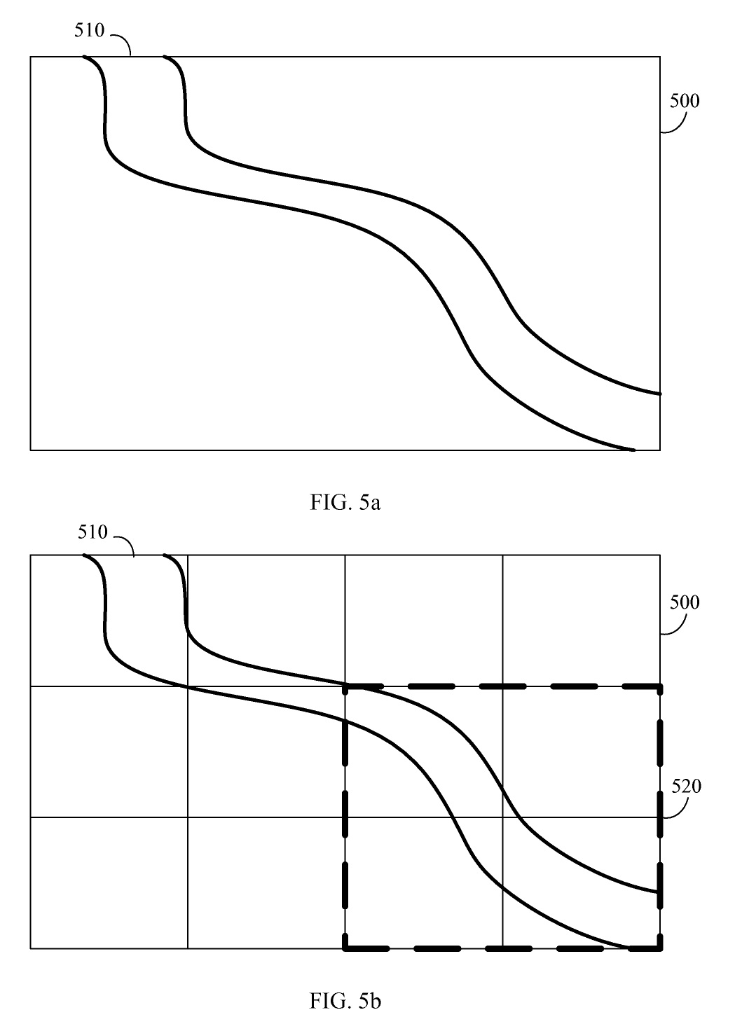

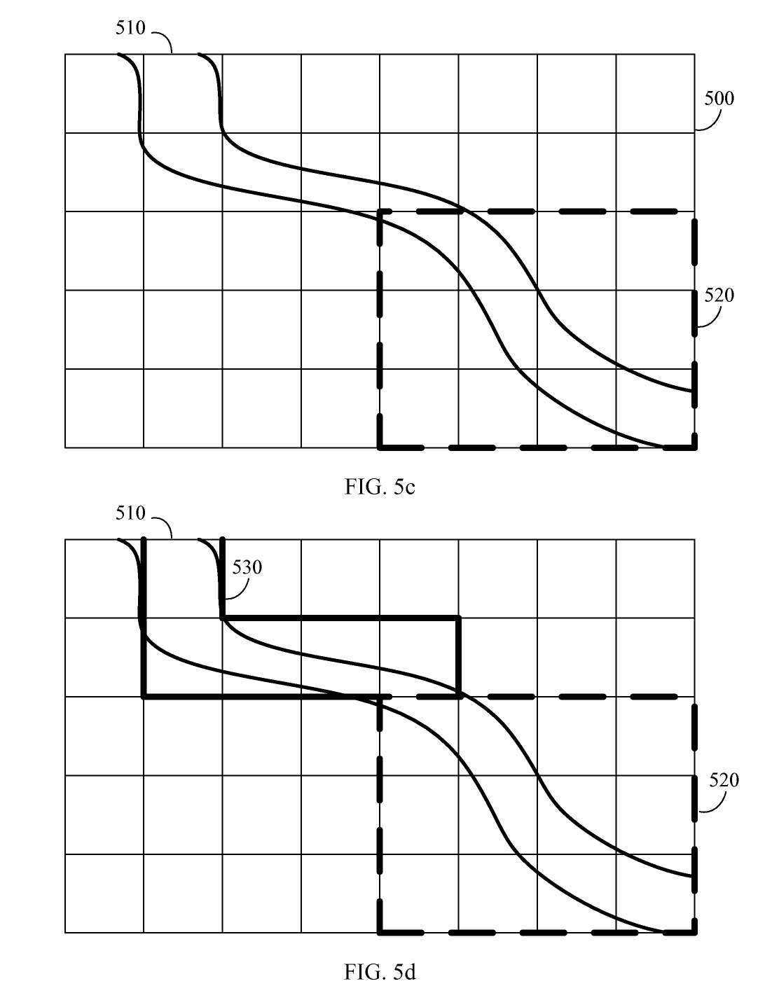

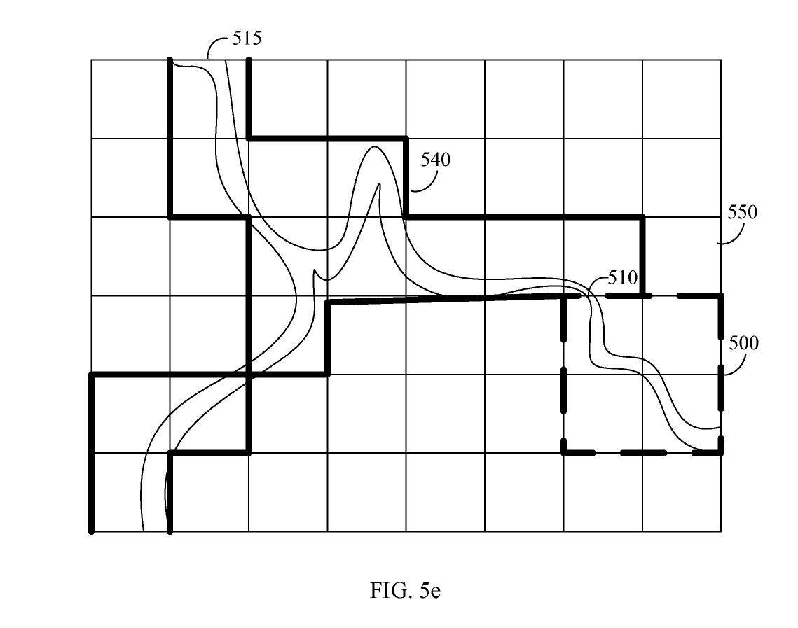

FIGS. 5a to 5e are diagrams depicting one example of data processed by the methods disclosed herein. The depicted example corresponds to a geographic space 500. FIG. 5a shows the geographic space 500 before it begins the processing stages. The geographic space may contain a multitude of geographic features; for the sake of simplicity, only a river 510 is highlighted to showcase the method.

FIG. 5b depicts the initial partitioning of the geographic space 500. The region 520 inside the dashed box represents the data blocks that have already been analyzed by the user. FIG. 5c depicts repartitioning, by the execution manager 12, the geographic space 500 in reaction to the analysis of the initial region 520. For example, the initial partitioning did not yield results with enough granularity, and therefore smaller data blocks need to be processed as is depicted in FIG. 5c.

FIG. 5d depicts reprioritizing, by the execution manager, the remaining data blocks in reaction to the analysis of the initial region 520. An analysis of the initial region 520 may focus on data blocks with a key characteristic, such as blocks related to the river 510 in this case. The remaining data blocks in the geographic space 500 may then be reprioritized such that the data blocks that are like those being interacted with the most, i.e. the set of outlined data blocks 530 which are related to the river 510, will be of higher priority than the other remaining data blocks, and will thus be processed first. In some embodiments, secondary prioritization occurs as well. For example, within the blocks related to the river 510 there are blocks with more river coverage than others. The blocks with the most river coverage could be prioritized to be executed before the blocks with less river coverage.

FIG. 5e depicts speculation on new tasks that need to be executed based on the analysis of the initial region 520. FIG. 5e depicts a large geographic space 550 that contains the initial geographic space 500, represented here within the dashed box. If the initial tasks only comprised processing data blocks within the geographic space 500, speculation may conclude that the outlined data blocks 540 need to be processed as well, as they are related to a river 515, of which the river 510 is a part. The user's interaction with the results from the data blocks within the geographic space 500 related to the river 510 will cue the system that data blocks related to rivers may all be of interest and therefore need to be scheduled to be processed.

FIG. 6 is a block diagram depicting components of a computer 600 in accordance with an illustrative embodiment of the present invention. In an embodiment of the present invention, computer 600 includes components of computing infrastructure 140. It should be appreciated that FIG. 6 provides only an illustration of one implementation and does not imply any limitations with regard to the environments in which different embodiments may be implemented. Many modifications to the depicted environment may be made.

As depicted, the computer 600 includes communications fabric 602, which provides communications between computer processor(s) 604, memory 606, persistent storage 608, communications unit 612, and input/output (I/O) interface(s) 614. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer readable storage media. In the depicted embodiment, memory 606 includes random access memory (RAM) 616 and cache memory 618. In general, memory 606 can include any suitable volatile or non-volatile computer readable storage media.

One or more programs may be stored in persistent storage 608 for execution by one or more of the respective computer processors 604 via one or more memories of memory 606. The persistent storage 608 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 612, in these examples, provides for communications with other data processing systems or devices. In these examples, communications unit 612 includes one or more network interface cards. Communications unit 612 may provide communications through the use of either or both physical and wireless communications links. I/O interface(s) 614 allows for input and output of data with other devices that may be connected to computer 600. For example, I/O interface 614 may provide a connection to external devices 620 such as a keyboard, keypad, a touch screen, and/or some other suitable input device. External devices 620 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 608 via I/O interface(s) 614. I/O interface(s) 614 also connect to a display 622. Display 622 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments disclosed herein include a system, a method, and/or a computer program product. The computer program product may include a computer readable storage medium (or media) having computer readable program instructions thereon for causing a processor to carry out the methods disclosed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method, executed by a computer, the method comprising:
receiving a set of tasks to be executed on an array of data;
receiving a user profile for a user;
prioritizing the set of tasks based, at least in part, on the user profile to provide a plurality of prioritized tasks;
partitioning the array of data based, at least in part, on a current task of the plurality of prioritized tasks to provide a plurality of data blocks;
prioritizing the plurality of data blocks based, at least in part, on the user profile to provide a plurality of prioritized data blocks;
executing the current task on the plurality of prioritized data blocks in order of priority to provide data results; and
outputting data results to the user for a first data block of the plurality of prioritized data blocks in response to completing the current task on the first data block.

2. The method of claim 1, further comprising monitoring a plurality of user interactions with the data results.

3. The method of claim 2, further comprising updating the user profile according to the plurality of user interactions, wherein the plurality of user interactions include at least one of: a user interaction with a cursor, and a user interaction with a keyboard.

4. The method of claim 1, wherein the user profile comprises information selected from user experience information, user preference information, and data results interaction information.

5. The method of claim 1, further comprising receiving a task profile, wherein the task profile comprises at least one of: an analysis type or and an analysis activity.

6. The method of claim 5, further comprising prioritizing the plurality of data blocks based, at least in part, on the user profile and the task profile to provide the plurality of prioritized data blocks.

7. The method of claim 1, further comprising speculating on one or more additional tasks to be executed based, at least in part, on the user profile and the plurality of user interactions with data.

8. The method of claim 1, wherein the set of tasks is executed on an elastic execution platform.

9. A computer program product for overlapping computer processing and human analysis, the computer program product comprising:
one or more computer readable storage media and program instructions stored on the one or more computer readable storage media, the program instructions comprising instructions to:
receive a set of tasks to be executed on an array of data;
receive a user profile for a user;
prioritize the set of tasks based, at least in part, on the user profile to provide a plurality of prioritized tasks;
partition the array of data based, at least in part, on a current task of the plurality of prioritized tasks to provide a plurality of data blocks;
prioritize the plurality of data blocks based, at least in part, on the user profile to provide a plurality of prioritized data blocks;
execute the current task on the plurality of prioritized data blocks in order of priority to provide data results; and
output data results to the user for a first data block of the plurality of prioritized data blocks in response to completing the current task on the first data block.

10. The computer program product of claim 9, wherein the program instructions comprise instructions to monitor a plurality of user interactions with the data results.

11. The computer program product of claim 9, wherein the program instructions comprise instructions to update the user profile according to the plurality of user interactions, wherein the plurality of user interactions include at least one of: a user interaction with a cursor, and a user interaction with a keyboard.

12. The computer program product of claim 9, wherein the user profile comprises information selected from user experience information, user preference information, and data results interaction information.

13. The computer program product of claim 9, wherein the program instructions comprise instructions to speculate on one or more additional tasks to be executed based, at least in part, on the user profile and the plurality of user interactions with data.

14. The computer program product of claim 9, wherein the set of tasks is executed on an elastic execution platform.

15. A computer system, the computer system comprising:
one or more computer processors;
one or more computer readable storage media;
program instructions stored on the computer readable storage media for execution by at least one of the computer processors, the program instructions comprising instructions to:
receive a set of tasks to be executed on an array of data;
receive a user profile for a user;
prioritize the set of tasks based, at least in part, on the user profile to provide a plurality of prioritized tasks;
partition the array of data based, at least in part, on a current task of the plurality of prioritized tasks to provide a plurality of data blocks;
prioritize the plurality of data blocks based, at least in part, on the user profile to provide a plurality of prioritized data blocks;
execute the current task on the plurality of prioritized data blocks in order of priority to provide data results; and
output data results to the user for a first data block of the plurality of prioritized data blocks in response to completing the current task on the first data block.

16. The computer system product of claim 15, wherein the program instructions comprise instructions to monitor a plurality of user interactions with the data results.

17. The computer system product of claim 15, wherein the program instructions comprise instructions to update the user profile according to the plurality of user interactions, wherein the plurality of user interactions include at least one of: a user interaction with a cursor, and a user interaction with a keyboard.

18. The computer system product of claim 15, wherein the user profile comprises information selected from user experience information, user preference information, and data results interaction information.

19. The computer system product of claim 15, wherein the program instructions comprise instructions to speculate on one or more additional tasks to be executed based, at least in part, on the user profile and the plurality of user interactions with data.

20. The computer system product of claim 16, wherein the set of tasks is executed on an elastic execution platform.
